(19) United States
(12) Patent Application Publication
(10) Pub. No.: US 2008/0229631 A1
(43) Pub. Date: Sep. 25, 2008

(54) Decorative Coin Assembly

(76) Inventors: Avram C. Freedberg, Stamford, CT (US); Mary Elizabeth Dale, Valhalla, NY (US); Michael R. Iozzo, Bronx, NY (US); Bill G. Grau, Villa Park, CA (US); Bob W. Grau, Orange, CA (US)

Correspondence Address: GORDON & JACOBSON, P.C., 60 LONG RIDGE ROAD, SUITE 407, STAMFORD, CT, 06902, US

(21) Appl. No.: 11/689,689

(22) Filed: Mar. 22, 2007

(51) Int. Cl. G09F 3/02

(52) U.S. Cl. 40/27.5

(57) ABSTRACT

A commemorative coin assembly includes a coin, a decorative component, and a holder that couples the component to the coin. The decorative component may be extended substantially perpendicularly from the coin's surface in a first position or alternatively inset into an outlined negative space on the coin's surface in a second position. The commemorative coin assembly depicts a central theme through the incorporation of engravings, etchings, letterings, motifs, numerals, or artistic depictions used on the decorative component or on the faces of the coin itself.

### BACKGROUND OF THE INVENTION

1. Field of the Invention

This invention relates broadly to decorative coin assemblies. In particular, this invention relates to a coin assembly having a three dimensional aspect. As set forth hereinafter in the specification, for purposes of the specification and claims, the term “coin” as used herein, unless otherwise indicated, shall have a broader meaning than the numismatic meaning and shall mean a small metallic disc having two faces (sides) and a diameter not greater than three inches which provides some intrinsic value to its owner.

2. State of the Art

According to the numismatic meaning, coins are generally small pieces of metal, usually flat and circular, issued by a national government for use as money. Although polygonal coins have been used, coins usually range in diameter from about two-thirds of an inch (e.g., a dime) to diameters greater than an inch (e.g. a coined half-dollar or dollar). Coins are sized so that they can easily be carried by an individual. Coins typically have axial thicknesses less than one-tenth of an inch. Thus, coins are generally viewed as being two-dimensional.

Government issued coins are typically made from metals or metal alloys materials. Typical metals presently used in the production of government issued coins include copper, nickel, and zinc. These metals in turn give the coin a distinctive, recognizable color. Color can be added by thinly plated layers of a metal (e.g. silver) to the surfaces of the coin, although in the past, precious metals have been used for coins to provide intrinsic value to the coin.

Modern government issued coins may include a number of designs and structural features to yield distinguishing qualities. Coins frequently include uniformly spaced ridges along their sides. Ornamental designs on the faces of coins also add distinguishing qualities including engravings, etchings, letters, numerals, symbols, and artistic depictions.

As an example, it is common for U.S. government issued coins to include depictions of national themes such as the American eagle, the Capitol building, or images of past U.S. presidents. Another common motif used on some U.S. government issued coins is the inscription “In God We Trust” on one face of the coin. Additionally, U.S. government issued coins are commonly minted with the year of production engraved at the lower portion of one face. These examples when used in combination with one another relate to a common American theme.

Collectible coins may be legal currency issued by a government to commemorate a particular person, place, or event. As an example, the Susan B. Anthony dollar coin was minted between 1979 and 1981 to commemorate the U.S. women's suffrage movement. Although not technically a “commemorative” (which according to the numismatist definition is legal currency which is not intended to be used as circulating currency), this collectible coin included an image of Susan B. Anthony below the word “Liberty” and along side the words “In God We Trust” on one face. On the opposite face was an artistic image of an American eagle flying above the moon. Collectively, these elements present a thematic association of the women's suffrage movement with American ideals.

Alternatively, a collectible coin may more simply be a souvenir commemorative coin that is not legal currency. Commemorative coins are made in tribute to any desired theme and include artistic depictions, engravings, etchings, or lettering elements to reflect the desired theme. For example, a coin designed to commemorate the first launching of the space shuttle might include an image of the shuttle below the name “Columbia” and the numeral “1981” to represent the year it was first launched.

Another example of a collectible coin having a decorative, thematic design is found in U.S. Pat. No. 6,205,816 to Lu. The coin of Lu has a hollow space for the insertion of an overlapping dual heart structure. The dual heart structure is affixed to a member attached to the interior surface of the hollow space. Once assembled, this coin can be used as a decorative display or used as a pendant.

Those skilled in the art will also appreciate that because of their two-dimensional aspect, display apparatuses are often necessary to facilitate display of commemorative coins. It will also be apparent to one skilled in the art the desirability of displaying the commemorative features of the coin without the use of a display apparatus. Thus there remains a desire in the art to provide commemorative coin assemblies with different mechanisms for displaying the commemorative aspects of the coin.

### SUMMARY OF THE INVENTION

It is therefore an object of the invention to provide a commemorative coin assembly that provides a three-dimensional presentation.

It is another object of the invention to provide a decorative coin assembly that provides a unique sense of value to the owner.

It is a further object of the invention to provide a decorative coin assembly that has an ornamental structural element that may be extended substantially perpendicularly from the coin's surface in a first position or alternatively inlaid into an outline on the coin's surface in a second position.

In accord with these objects, which will be discussed in detail below, a decorative coin assembly according to the invention is provided and includes a coin, a component separately formed from the coin, and a means for holding the component in a position relative to the coin.

The coin of the present invention is preferably round and may have a range of thickness to diameter ratios. It may be composed of any number of alloys or metals such as copper, nickel, or zinc to name a few examples. These metals may in turn cause the coin to assume different colors. Alternatively, the coin may be plated with a second metal to provide a desired appearance. In addition, the coin of the present invention preferably includes lettering or engravings. Further, the coin preferably includes thematic representations and/or structural features. In one embodiment, the coin is provided with an outline which defines a negative space for the inlay of the separately formed component in a first position.

The separately formed component preferably includes thematic representations and/or structural features and may also include lettering or engravings. The thematic representations, structural features, lettering, engravings, or thematic representations of the component preferably relate to the respective theme of the coin. The separately formed component may also include a fitting element to couple the component to the coin in a second position.

The means for holding the component is provided to couple the separately formed component to the coin such that the separately formed component can assume a substantially perpendicular position relative to the coin. This holding means may be an additional separately formed support element or may be a part of the coin or component itself. Examples of such support elements include but are not limited to holding pieces, slots, grooves, or notches.

The decorative coin assembly may also include an easel for the separate display of the second component piece.

Additional objects and advantages of the invention will become apparent to those skilled in the art upon reference to the detailed description taken in conjunction with the provided figures.

### BRIEF DESCRIPTION OF THE DRAWINGS

FIG. 1 is a side view of the commemorative coin assembly of the invention.

FIG. 2 is a top view of the coin and separately formed component of FIG. 1.

FIG. 3 is a top view of the commemorative coin of FIG. 1 without the separately formed component.

FIG. 4 is a top view of the separately formed component.

FIG. 5 is a top view of a holder for the first embodiment of FIG. 1.

FIG. 6 is an enlarged perspective view partially in phantom of a second embodiment of the commemorative coin assembly.

FIG. 7A is a top view of the commemorative coin and separately formed component of FIG. 6.

FIG. 7B is a side view of the commemorative coin and separately formed component of FIG. 6.

FIG. 8 is a top view of the commemorative coin of FIG. 6 without the separately formed inlay component.

FIG. 9 is a top view of the separately formed component of FIG. 6.

FIG. 10 is a top view of a holder useful in conjunction with the separately formed component of FIG. 9.

FIG. 11 is a side view of a coin with the holder of FIG. 10 laying on the coin.

FIG. 12 is a side view of a coin assembly with the coin and holder of FIG. 11 and the separately formed component of FIG. 9 in an upright position.

FIG. 13A is a perspective view of the top of a two part casing for holding a commemorative coin.

FIG. 13B is a perspective view of the bottom of a two-part casing for holding a commemorative coin.

FIG. 14 is a perspective view of an easel for holding a commemorative coin.

### DETAILED DESCRIPTION OF THE PREFERRED EMBODIMENTS

As previously set forth, for purposes of the specification and claims, the term “coin” as used herein, unless otherwise indicated, shall have a broader meaning than the numismatic meaning and shall mean a small metallic disc having two faces (sides) and a diameter not greater than three inches which provides some intrinsic value to its owner.

For purposes of the specification and claims, the term “commemorative” as used herein, unless otherwise indicated, shall have a broader meaning than the numismatic meaning and is to be understood in its broadest sense to mean honoring or preserving the memory of a person, place, thing, or event.

For purposes of the specification and claims, the term “character” as used herein is to be understood in its broadest sense to mean a graphic symbol as used in writing or printing such as a letter, hieroglyph, or symbol that can be typed from a standard computer keyboard.

For purposes of the specification and claims, the term “theme” as used herein is to be understood in its broadest sense to mean a unifying or dominant idea or motif as in a work of art.

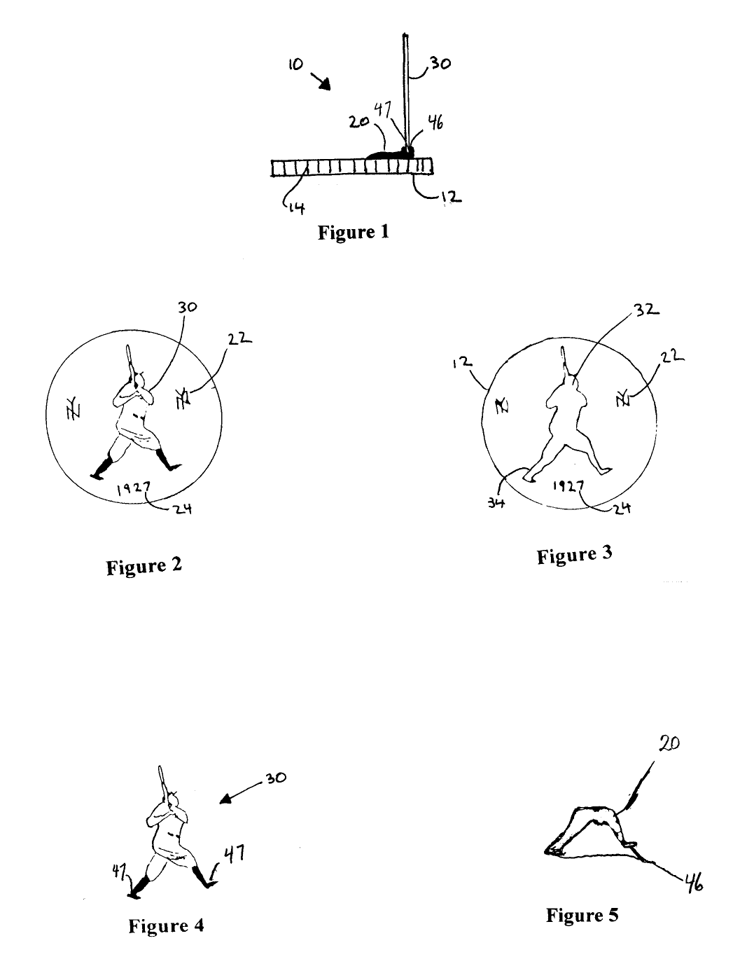

Turning now to FIGS. 1-4, a commemorative coin assembly 10 is shown having three parts in a preferred embodiment. The commemorative coin assembly 10 includes a coin 12, a holder 20, and a separately formed component 30. In a first position shown in FIG. 1, the separately formed component 30 is coupled to the holder 20 as the holder 20 sits on one face of the coin 12. In this position the separately formed component 30 is substantially perpendicular (90°+/−20°) to a face of the coin 12 forming angles between 70° and 110°. This first position permits viewing of the separately formed component 30 when the coin 12 is positioned flat upon a surface such as a desktop or display case shelf. As seen in FIG. 2, the separately formed component 30 assumes a second position relative to the coin 12. Here, the separately formed decorative component 30 is positioned onto one face of the coin 12.

The coin 12 may possess unique structural or color features. As an example, ridges 14 are shown as a decorative element along the side perimeter of the coin 12. The color of the coin 12 is usually controlled by its metallic body composition. However, the coin 12 may also be plated with metals such as gold, platinum, or silver to give the appearance of a solid precious metal having intrinsic material value.

The coin 12 preferably has a diameter of between about 0.5 inches and 2.0 inches and a thickness of between one-sixteenth and one-quarter of an inch. The coin 12 also preferably includes decorative designs to define a theme on front and back faces such as engravings or etchings including logos 22 or characters 24. Collectively these decorative designs coordinate with the theme presented by separately formed component 30.

As illustrated by FIG. 2, in the first embodiment the coin 12 and separately formed component 30 artistically depict a theme on the coin 12: Babe Ruth. In this case, the separately formed component 30 is a representation of Babe Ruth assuming a home run pose. Thematic emphasis is added by an engraving of the logo 22 representing the New York Yankees. Additional thematic emphasis is added by placement of the characters 24 on the coin 12 representing the year “1927” in which Ruth hit a record 60 home runs. The separately formed component 70 also contains multiple colors to artistically highlight aspects of Babe Ruth's uniform such as distinctions between his uniform and socks. The multiple colors may be obtained by utilizing different metals or metal plates to form the separately formed component 70 or by painting the separately formed component 70 with one or more colors. The coordinated theme of Babe Ruth herein is presented only as an example and it is not intended to limit the scope of potential themes that can be incorporated into the invention. Similar logos and engravings may be presented on the back of the coin 12. For example, the back of the coin might depict Yankee Stadium.

Turning now to FIG. 3, a top (i.e. front face) of the coin 12 is shown having a negative space 32. The negative space 32 is an area in the surface of the coin 12 outlined to receive the holder 20 in the first position (FIG. 1) and/or the separately formed component 30 in the second position (FIG. 2). The negative space 32 preferably does not create an opening through the body of the coin 12 as the coin 12 is solid. Rather, negative space 32 is defined by either a ridge 34 on the coin 12 extending up from the face of the coin and/or an indent in the face of the coin 12. The depth of the negative space 32 is defined as the distance from top of the ridge (if any) to the bottom of the indent and is preferably less than the thickness of the separately formed component 30 so that the front face of the separately formed component 30 extends above the front face of the coin 12.

As seen in FIGS. 1-4, the separately formed component 30 is effectively a two-dimensional element having a narrow thickness not greater than one-eighth of an inch in a preferred configuration, and not greater than one-sixteenth of an inch in a more preferred configuration. In this manner, when separately formed component 30 is placed in the negative space 32, it extends slightly above the front face of the coin 12.

The holder 20 is shown in FIG. 5 and is placed into the negative space 32 (shown in FIG. 3) to support separately formed component 30. The holder 20 preferably has a narrow thickness not greater than one-sixteenth of an inch and is effectively a two-dimensional element. The holder 20 may occupy the entirety of the negative space 32, or as suggested with respect to holder 20 of FIG. 5 which represents the waist-down portion of Babe Ruth, only a portion of the negative space. As seen in FIGS. 1 and 5, the holder 20 as shown has a female fitting element in the form of slots 46 (at the feet area) adapted to receive a mating portion (in this case the feet 47) of the separately formed component 30 in the first position.

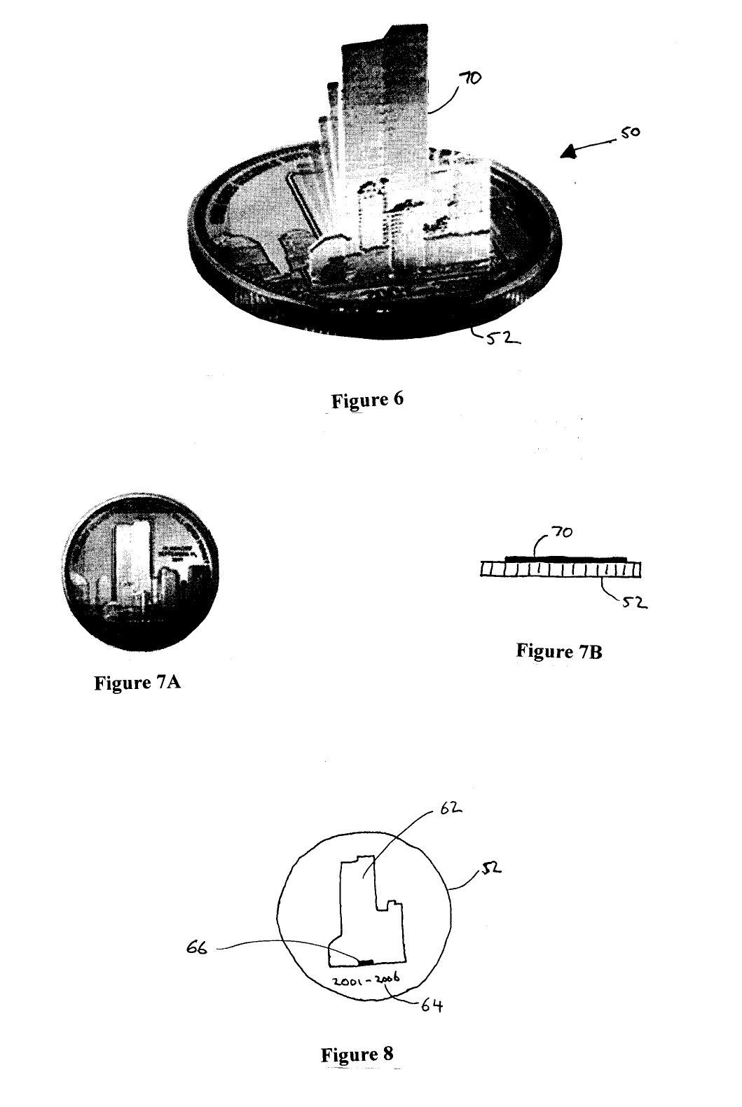

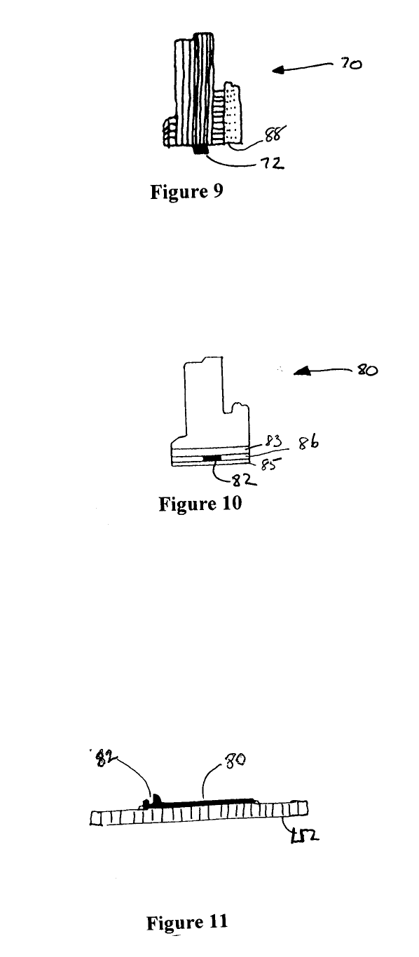

FIGS. 6-9 depict a second embodiment of the invention having a theme commemorating the World Trade Center towers. As seen in FIG. 6, a photographic depiction of a commemorative coin assembly 50 is shown having a coin 52 plated in gold, a separately formed component 70 plated in silver in a first position substantially perpendicular to the coin 52, and a holding means described hereinafter in FIGS. 9-10. The contrast of the silver color of the separately formed component 70 against the gold color of the coin 52 distinctly highlights each element. The separately formed component 70 in this embodiment is an artistically engraved depiction of the World Trade Center towers accompanied by a limited number of surrounding buildings. Phantom images of the separately formed component 70 are seen in FIG. 6 to show that the separately formed component 70 may be lifted from a second position to the first position and returned from the first position to the second position.

As seen in FIG. 7A, the coin 52 has decorative elements on both faces which coordinate with the theme of the separately formed component 70. Here, the coin 52 includes the characters 64 which read, “in memory of Sep. 11, 2001” entirely in capital letters on the right side of the separately formed component 70. Above the separately formed component 70 and inside the circumference of the coin, additional characters state, “even grief recedes with time, but we will never forget,” again entirely in capital letters. The characters “2001-2006” are engraved below the separately formed component 70. The separately formed component 70 is also surrounded by engraved buildings 58 representing the New York City skyline. Collectively, these character inscriptions emphasize the central theme of separately formed component 70 which depicts the World Trade Center towers. It should be noted however that other inscriptions and engravings may be envisioned by one of ordinary skill in the art to emphasize this commemorative theme. As seen in FIG. 7B, a side view of the collective coin assembly in the second position shows that the separately formed component 70 may extend an appreciable distance above the surface of the coin 52.

As seen in FIG. 8, the coin 52 has the negative space 62 for reception of the separately formed component 70. The negative space 62 is an outline of the World Trade Center towers and accompanying buildings defined by perimeter of the separately formed component 70. The coin 52 may optionally include a female fitting element such as a slot or notch 66 which preferably extends only partially into the coin and is used to receive a male fitting element 72 (FIG. 9) extending from the separately formed component 70. When a female fitting element such as the slot or notch 66 is present, additional support structures such as holders are unneeded to realize the first position of the decorative coin assembly 50. When a male fitting element 72 from the separately formed component 70 coincides with a female fitting element such as the slot or notch 66 of the coin 52, the separately formed component 70 stands substantially perpendicular to the surface of coin 52 in the desired first position. The female fitting element may also be a groove or another equivalent as envisioned by one of ordinary skill in the art.

In FIG. 9, the separately formed component 70 is shown including the male element 72. The male element 72 may be coupled to either a female fitting element in the coin 52 or in a holder (as described hereinafter). The male element 72 is preferably an extension of the separately formed component 70 or may be a peg, prong, tab, or other equivalents as envisioned by one of ordinary skill in the art.

In FIG. 10, an example of a holding means for coupling the separately formed component 70 to the coin 52 is shown as a holder. The holder 80 is a support device that sustains the separately formed component 70 in the first position of the commemorative coin assembly. The holder 80 is preferably made of clear plastic and shaped to match the outline of the negative space 62 for placement therein. As shown, the holder 80 is substantially flat, but includes two raised ribs 83 and 85 which define a groove 86 therebetween, and a slot 82 (female element) extending through the plastic in the grooved area. With the groove and slot, the bottom 88 (FIG. 9) of the separately formed component 70 will engage the groove 86 while the male element 72 will engage the female element slot 82. While a separate holder such as the holder 80 is not required to sustain the separately formed component 70 in the first position relative to the coin 52 of FIG. 6 because the coin 52 has its own holder in the form of a notch or slot 66, the holder 80 of FIG. 10 can still be utilized in conjunction with the coin 52 and the separately formed component 70 if desired.

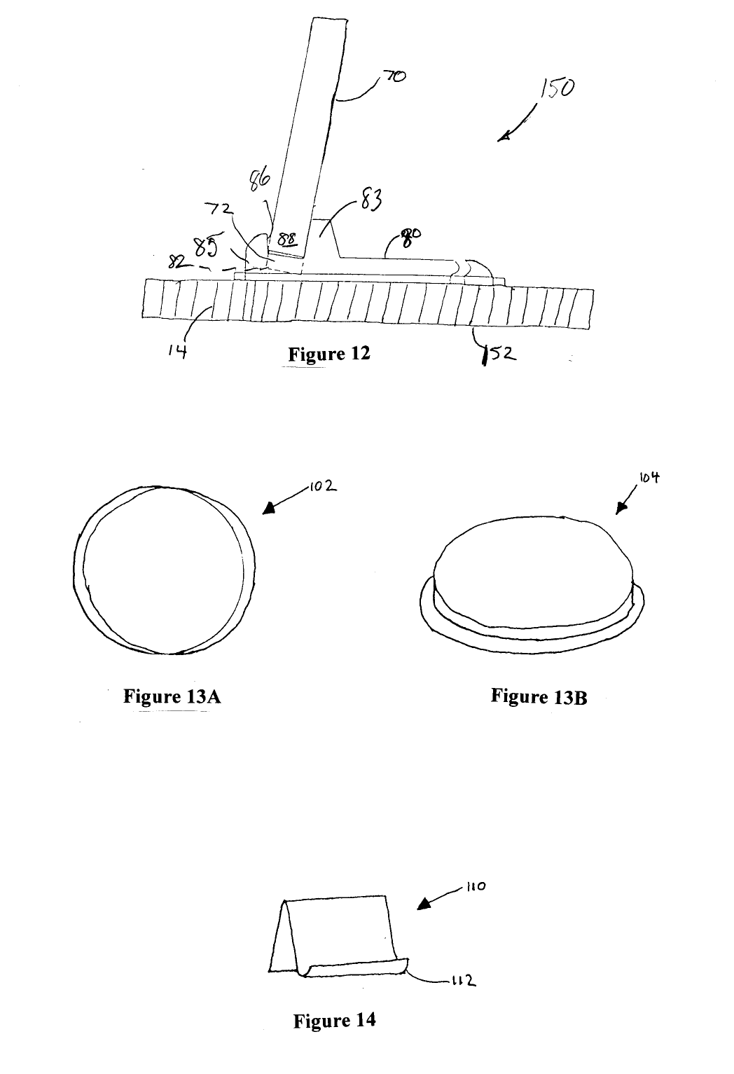

Turning now to FIGS. 11 and 12, a decorative coin assembly 150 has a coin 152 which is substantially identical to coin 52 of FIG. 6 except that it does not include a holder formed as part of the coin (i.e., it does not have a notch or slot 66). Thus, the coin assembly 150 uses a holding means such as the holder 80 of FIG. 10 which has a female fitting element such as a slot 82. The holder 80 is placed in the negative space of the coin 152. However, it is not necessary that the holder 80 occupy the entirety of the space or that a negative space be provided. Instead, holder 80 structurally strong enough to support on its own the separately formed component 70 (FIG. 9) in the first position. As seen in FIG. 12, the first position of the commemorative coin assembly 50 is realized by the coupling of the bottom 88 of the separately formed element 70 in the groove 86 of holder 80, and the coupling of the male fitting element 72 of the separately formed component 70 in the slot 82 of the holder 80.

As will be appreciated by those skilled in the art, the holding means of the invention can refer to any element or combination of elements which couple the separately formed component to the coin. Such holding means may include the use of an intermediary structural support element. Alternatively, holding means may refer to the coupling of male and female fitting elements attached or imbedded into the separately formed component and the coin. Holders and male-female fitting elements as presented herein provide examples of holding means and are not intended to limit the holding means to the examples presented.

As shown in FIG. 12, the separately formed component 70 of the commemorative coin assembly 150 may assume a tilt in the first position. After the holder 80 is positioned into the negative space of the coin 152, the separately formed component 70 is placed into the holder 80. This positioning preferably occurs by the insertion of the male element 72 into the female element 82 of the holder 80. This insertion causes the separately formed component 70 to be coupled to the coin 152 in the first position of the commemorative coin 50.

The substantially perpendicular angle of display of the separately formed component as incorporated into decorative coin assembly serves two important functions. First, this angle provides a unique way of viewing the separately formed component when the plane of view of the coin is flush relative to an observer. Second, variations in the angles can be used to assist the thematic presentation of the commemorative coin assembly generally. For example, the invention herein described could be used to make a coin assembly commemorating the leaning tower of Pisa having a distinct slant of 5.5°. Although “substantially perpendicular” has been defined to mean having an angle of 90°+/−20° such that the tilt of separately formed component 70 in FIG. 12 is still substantially perpendicular, it will be evident to one of ordinary skill in the art that the female element, the slot, or the holder can be configured so that the separately formed component can assume a wider range of angles relative to the plane of the coin without deviating from the spirit of the invention described herein.

The previously described commemorative coin assemblies 10, 50, 150 may be provided with a round casing closed by the union of casing top 102 of FIG. 13A and casing bottom 104 of FIG. 13B. The casing is preferably made of a clear plastic such that a coin with a separately formed component inlaid in the second position can be seen within the casing for viewing while also serving the protective function of preventing the coins from being undesirably scratched. From the closed casing position, the casing top 102 and casing bottom 104 may be easily separated from each other by prying or pulling at the base of the casing top 102 to allow removal of the decorative coin assembly elements.

Turning to FIG. 14, an easel 110 is provided for display of the commemorative coin with the separately formed component. For example, a coin may be placed upon an easel support member 112 such that the coin is displayed at an angle. This angle is determined by the geometry of the easel 110 and may be customized as desired.

There have been described and illustrated herein several embodiments of a commemorative coin assembly and methods of display. While particular embodiments of the invention have been described, it is not intended that the invention be limited thereto, as it is intended that the invention be as broad in scope as the art will allow and that the specification be read likewise. Thus, while particular examples of commemorative coin assemblies have been disclosed, it will be appreciated that a variety of other thematic presentations may be incorporated into the same coin assembly design as well. For example and not by way of limitation, a commemorative coin assembly could incorporate a design of a college mascot as the separately formed component including associated school themes placed on the coin. As a further example, the commemorative coin assemblies described herein could also incorporate a theme having an American flag. Furthermore, while a round commemorative coin is presented herein, it will be understood that a small medallion can be similarly used. Moreover, while particular configurations have been disclosed in reference to commemorative coin assemblies, it will be appreciated that other configurations could be used as well. It will therefore be appreciated by those skilled in the art that yet other modifications could be made to the provided invention without deviating from its spirit and scope as claimed.

What is claimed is:

1. A decorative coin assembly, comprising:
a) a coin having a first face, a second face, and a thickness;
b) a component separately formed from said coin including a flat side such that said component is substantially perpendicular to said first face in a first position and assumes a second position with said flat side on said first face; and
c) holding means for coupling said component relative to said coin to support said component in said second position.

2. The decorative coin assembly of claim 1, wherein:
said coin has a metallic color chosen from one of bronze, copper, gold, nickel, and silver.

3. The decorative coin of claim 2, wherein:
said component has a color that is different than said metallic color of said coin.

4. The decorative coin assembly of claim 1, wherein:
said component depicts an image of at least one building.

5. The decorative coin assembly of claim 1, wherein:
said coin includes at least one engraved character.

6. The decorative coin assembly of claim 1, wherein:
said coin includes at least one thematic or decorative design.

7. The decorative coin assembly of claim 1, wherein:
a negative space of said component is defined on said coin.

8. The decorative coin assembly of claim 1, wherein:
said holding means includes a male fitting element or a female fitting element on said component or on said coin.

9. The decorative coin assembly of claim 8, wherein:
said female fitting element includes a groove, a notch, or a slot on said coin.

10. The decorative coin assembly of claim 8. wherein:
said male fitting element includes a peg, a prong, or a tab on said component.

11. The decorative coin assembly of claim 1, wherein:
said holding means is a structural support element.

12. The decorative coin assembly of claim 1, further comprising:
a clear casing for housing said coin with said component.

13. The decorative coin assembly of claim 1, wherein:
said coin is solid.

14. A decorative coin assembly, comprising:
a) a coin including a formed decorative face having a theme;
b) a component having a second decorative theme corresponding to the formed decorative face of said coin;
c) a holder which couples said component to said coin to support said component in a first position; and
d) a negative space on said coin defined by an outline of said component wherein said component is placed into a second position.

15. The decorative coin assembly of claim 14, wherein:
said holder includes a male fitting element or a female fitting element.

16. The decorative coin assembly of claim 15, wherein:
said female fitting element is a groove, a notch, or a slot.

17. The decorative coin assembly of claim 16, wherein:
said male fitting element is a peg, a prong, or a tab.

18. The decorative coin element of claim 14, wherein:
said component is substantially perpendicular to said coin when in said first position.

19. A decorative coin assembly, consisting essentially of:
a) a solid coin having a first face, a second face, a thickness, a metallic color and including at least one thematic or decorative design;
b) a component separately formed from said coin including a flat side such that said component is substantially perpendicular to said first face in a first position and assumes a second position with said flat side on said first face; and
c) holding means for coupling said component relative to said coin to support said component in said second position.

20. A decorative coin assembly according to claim 19, wherein:
said holding means includes a male fitting element or a female fitting element on said component or on said coin.
